(19) United States
(12) Patent Application Publication
(10) Pub. No.: US 2026/0078635 A1
(43) Pub. Date: Mar. 19, 2026

(54) COMPOSITE PANE WITH ELECTRO-OPTICAL FUNCTIONAL ELEMENT AND DESIGN ELEMENT

(71) Applicant: SAINT-GOBAIN SEKURIT FRANCE, Thourotte (FR)

(72) Inventors: Achim ZEICHNER, HERZOGENRATH (DE); Jefferson DO ROSARIO, HERZOGENRATH (DE); Matthias MANDELARTZ, HERZOGENRATH (DE); Ortwin REITZ, HERZOGENRATH (DE)

(21) Appl. No.: 19/107,243

(22) PCT Filed: Aug. 29, 2023
(86) PCT No.: PCT/EP2023/073599

§ 371 Date: Feb. 27, 2025

(30) Foreign Application Priority Data
Aug. 30, 2022 (EP) 22192827.8

(51) Int. Cl. E06B 9/24; B32B 3/30; B32B 7/025; B32B 7/12; B32B 27/06

(52) U.S. Cl. CPC E06B 9/24; B32B 3/30; B32B 7/025; B32B 7/12; B32B 27/06; B32B 2305/55; B32B 2307/408; B32B 2307/7376

(57) ABSTRACT

A composite pane includes an outer pane, a first thermoplastic intermediate layer, an electro-optical functional element, a second thermoplastic intermediate layer, a design element, and an inner pane. The functional element is arranged between the outer and inner panes. The first thermoplastic intermediate layer is arranged between the outer pane and the electro-optical functional element. The second thermoplastic intermediate layer is arranged between the electro-optical functional element and the inner pane. The design element is arranged in a region of the composite pane which, when viewed through the composite pane, lies completely in the region in which the electro-optical functional element is arranged. The functional element is electrically controllable from a first state, in which the electro-optical functional element has a first color, to a second state, in which the electro-optical functional element has a second color. The design element has a third color corresponding to the first color.

The invention relates to a composite pane with an electro-optical functional element and a design element.

Composite panes with electrically controllable optical properties are known as such. They comprise composite panes equipped with electro-optical functional elements, i.e. with functional elements whose optical properties can be changed by an applied voltage. Examples of electro-optical functional elements are SPD (suspended particle device) functional elements, known, for example, from EP 0876608 B1 and WO 2011033313 A1, and PDLC (polymer dispersed liquid crystal) functional elements, known, for example, from DE 102008026339 A1.

WO 2019/086653 A1 discloses a composite pane comprising a laminated stack sequence of an outer pane, a first intermediate layer, a second intermediate layer and an inner pane, and a functional element with electrically controllable optical properties, which is arranged at least in sections between the first intermediate layer and the second intermediate layer, wherein at least one transparent body is arranged in sections between the outer pane and the functional element and/or between the inner pane and the functional element. The contour of the transparent body remains visible to the human eye over the entire operating range of the functional element.

There is increasing interest in providing the composite panes with electrically controllable properties with characters, such as lettering, symbols, logos, trademarks or simple graphics, which visually stand out to an observer in one state of the electro-optical functional element and do not visually stand out to the observer in another state of the electro-optical functional element.

It is known to introduce switchable patterns into a PDLC element by laser segmentation. CN 110471206 A discloses a method for producing a PDLC film with patterns and/or texts by direct laser etching.

However, not every structure can be incorporated into a PDLC functional element using laser segmentation, since, for example, minimum distances between the laser lines and minimum radii must be taken into account.

WO 2021/105070 A1 discloses a method for producing an optical device that can be operated in at least two optical states and can be electrically switched between them, wherein in one of the optical states an image with at least one closed feature can be represented by a combination of open forms.

The object of the invention is to provide an improved composite pane with an electro-optical functional element and a design element. In addition, the composite pane should be able to be produced in a simple and cost-effective manner.

The object is achieved by a composite pane and by methods according to the independent claims.

The invention relates to a composite pane at least comprising an outer pane, a first thermoplastic intermediate layer, an electro-optical functional element, a second thermoplastic intermediate layer, a design element and an inner pane. The electro-optical functional element is arranged in a region of the composite pane between the outer pane and the inner pane. The first thermoplastic intermediate layer is arranged between the electro-optical functional element and the outer pane, and the second thermoplastic intermediate layer is arranged between the electro-optical functional element and the inner pane. The design element is arranged in a region of the composite pane which, when viewed through the composite pane, lies completely in the region in which the electro-optical functional element is arranged.

The electro-optical functional element can be electrically controlled from a first state, in which said functional element has a first color, to a second state, in which said functional element has a second color. In addition, the electro-optical functional element can also be electrically controlled conversely from the second state to the first state. It is understood that the first color and the second color of the electro-optical functional element are different, that is, the first color and the second color do not correspond to each other.

According to the invention, the design element has a third color which corresponds to the first color of the electro-optical functional element, i.e. the color of the electro-optical functional element in the first state. Thus, the electro-optical functional element in the first state and the design element have the same color. Since the first color and the second color of the electro-optical functional element do not correspond to each other and the third color of the design element corresponds to the first color of the electro-optical functional element, it is understood that the third color of the design element does not correspond to the second color of the electro-optical functional element. When the electro-optical functional element in the composite pane is in the first state, the design element does not stand out visually. The design element with its contours is therefore not recognizable as such by the observer when the electro-optical functional element is in the first state in the composite pane. The observer therefore perceives the electro-optical functional element together with the design element as a homogeneous element with a constant color. However, when the electro-optical functional element in the composite pane is in the second state, the design element stands out visually due to its third color. The observer can therefore clearly see the design element and its contours when the electro-optical functional element in the composite pane is in the second state.

The design element can be arranged in front of or behind the electro-optical functional element when viewed through the composite pane.

Preferably, the design element is arranged behind the electro-optical functional element as seen by the observer.

It is understood that the design element does not necessarily have to be formed in one piece; the design element can also be formed from several elements which can be arranged directly adjacent to one another or at a distance from one another. For example, the design element can be formed as lettering or as a symbol or a simple graphic or as a logo. The design element can, for example, also be formed as lettering and a simple graphic, with the lettering and the simple graphic being arranged in different regions of the composite pane. As explained above, the design element is arranged in a region of the composite pane which, when viewed through the composite pane, lies completely in the region in which the electro-optical functional element is arranged. It is understood that if the design element is formed from several elements, each of these elements, when viewed through the composite pane, lies completely in the region in which the electro-optical functional element is arranged.

In the context of the invention, when the composite pane is intended, in a window opening of a vehicle or of a building, to separate an interior space from the external environment, the pane facing the interior space (vehicle interior) is referred to as the “inner pane”. “Outer pane” means the pane facing the external environment. If the composite pane in a window opening in a building is intended to separate a room from the hallway for example, the inner pane, in the context of the invention, refers to the pane facing the interior space and the outer pane refers to the pane facing the hallway.

The outer pane and the inner pane in each case have an exterior-side and an interior-side surface and a circumferential side edge extending between them. In the sense of the invention, the exterior-side surface means the main surface which is intended to face the external environment when installed. In the sense of the invention, the interior-side surface means the main surface which is intended to face the interior when installed. The interior-side surface of the outer pane and the exterior-side surface of the inner pane face one another and are connected to one another by the thermoplastic intermediate layer.

The exterior-side surface of the outer pane is designated as side I. The interior-side surface of the outer pane is designated as side II. The exterior-side surface of the inner pane is designated as side III. The interior-side surface of the inner pane is designated as side IV.

In a preferred embodiment of a composite pane according to the invention, the design element is formed as an imprint on one of the pane surfaces. In an embodiment, the design element is formed as an imprint on the exterior-side surface of the outer pane. In an alternative embodiment, the design element is formed as an imprint on the interior-side surface of the outer pane. In an alternative embodiment, the design element is formed as an imprint on the exterior-side surface of the inner pane. In an alternative embodiment, the design element is formed as an imprint on the interior-side surface of the inner pane.

Preferred embodiments are those in which the design element is formed as an imprint on the exterior-side surface of the outer pane or as an imprint on the interior-side surface of the inner pane.

Particularly preferred are embodiments in which the design element is formed as an imprint on the interior-side surface of the outer pane or as an imprint on the exterior-side surface of the inner pane, since in these embodiments the design element is arranged inside the composite pane and is thus protected from external influences.

A design element formed as an imprint on one of the pane surfaces is typically made of an enamel containing glass frits and a pigment. By selecting the pigment, the third color of the design element can be set such that it corresponds to the first color of the electro-optical functional element. Suitable pigments are known to a person skilled in the art.

In an advantageous embodiment of the invention, a design element formed as an imprint on one of the pane surfaces has a thickness of 5 μm (micrometers) to 40 μm, preferably from 10 μm to 25 μm. In an alternative advantageous embodiment, a design element formed as an imprint on one of the pane surfaces has a thickness of less than 5 μm.

In an alternative preferred embodiment of a composite pane according to the invention, the design element is formed as an imprint on the first thermoplastic intermediate layer or as an imprint on the second thermoplastic intermediate layer. The imprint can be arranged on the first thermoplastic intermediate layer either on the surface which, in the composite pane, faces towards the outer pane or on the surface which, in the composite pane, faces towards the electro-optical functional element. The imprint can be arranged on the second thermoplastic intermediate layer either on the surface which, in the composite pane, faces towards the inner pane or on the surface which, in the composite pane, faces towards the electro-optical functional element.

Preferably, in these embodiments, the imprint is arranged on the first thermoplastic intermediate layer on the surface which, in the composite pane, faces towards the outer pane or on the second thermoplastic intermediate layer on the surface which, in the composite pane, faces towards the inner pane. This arrangement of the imprint is particularly advantageous because the first or second thermoplastic intermediate layer is in this case arranged between the imprint and the electro-optical functional element, thus preventing the design element from exerting pressure on the active layer of the electro-optical functional element.

A design element formed as an imprint on the first thermoplastic intermediate layer or as an imprint on the second thermoplastic intermediate layer is typically formed from a composition containing water-based or solvent-based color pigments or dyes.

In an advantageous embodiment of the invention, a design element formed as an imprint on the first thermoplastic intermediate layer or the second thermoplastic intermediate layer has a thickness of 5 μm (micrometers) to 40 μm, preferably from 5 μm to 20 μm. In an alternative advantageous embodiment, a design element formed as an imprint on the first thermoplastic intermediate layer or the second thermoplastic intermediate layer has a thickness of less than 5 μm.

In an alternative preferred embodiment of a composite pane according to the invention, the design element is formed as an insert element. The insert element is a prefabricated element which is arranged in the stack of layers to be laminated during the production of the composite pane before lamination. A design element formed as an insert element can be arranged in the composite pane according to the invention between the electro-optical functional element and the first thermoplastic intermediate layer or between the electro-optical functional element and the second thermoplastic intermediate layer or between the first thermoplastic intermediate layer and the outer pane or between the second thermoplastic intermediate layer and the inner pane.

Preferably, the insert element is arranged between the outer pane and the first thermoplastic intermediate layer or between the inner pane and the second thermoplastic intermediate layer. This arrangement of the insert element is particularly advantageous because the first or second thermoplastic intermediate layer is in this case arranged between the insert element and the electro-optical functional element, thus preventing the insert element from exerting pressure on the active layer of the electro-optical functional element.

Preferably, the insert element comprises or consists of colored polyethylene terephthalate (PET), polyvinyl butyral (PVB), polyethylene (PE) or ethylene vinyl acetate (EVA).

The insert element is preferably between 10 μm (micrometers) and 80 μm, particularly preferably between 20 μm and 60 μm, most particularly preferably between 25 μm and 50 μm thick. In preferred embodiments, the insert element is 25 μm or 50 μm thick. In an alternative embodiment, the insert element can also be less than 5 μm thick.

In an alternative preferred embodiment of a composite pane according to the invention, the design element is formed as an adhesive tape, wherein the adhesive tape is stuck to the exterior-side surface of the outer pane, to the interior-side surface of the outer pane, to the exterior-side surface of the inner pane or to the interior-side surface of the inner pane.

Particularly preferred are embodiments in which the design element is formed as an adhesive tape stuck to the exterior-side surface of the outer pane or as an adhesive tape stuck to the interior-side surface of the inner pane, since in these cases the adhesive tape can in particular only be stuck on after the lamination of a stack sequence to form a composite pane and does not necessarily have to be stuck on before the lamination. In these embodiments, it is also possible to remove the design element from the pane to which it is stuck at a later point in time and to stick on a differently shaped design element in the form of an adhesive tape. The replacement of the design element is thus easily possible in these embodiments, in particular without damaging the other components of the composite pane according to the invention.

In an alternative preferred embodiment of a composite pane according to the invention, the design element is formed as a satin-finished region of one of the pane surfaces. In an embodiment, the design element is formed as a satin-finished region of the exterior-side surface of the outer pane. In an alternative embodiment, the design element is formed as a satin-finished region of the interior-side surface of the outer pane. In an alternative embodiment, the design element is formed as a satin-finished region of the exterior-side surface of the inner pane. In an alternative embodiment, the design element is formed as a satin-finished region of the interior-side surface of the inner pane.

A satin-finished region is a roughened region. The satin-finished region can be created on the pane surface by roughening the surface in question in the region to be satin-finished, for example by sandblasting or treatment with hydrofluoric acid (etching) or hydrofluoric acid vapor. The regions of the pane surface that are not to be satin-finished are covered, for example, by stencils and/or adhesive films. Stencils and adhesive films can also be created with computer support.

With the sandblasting technique, the pane surface can be blasted with sand in the desired region. However, for health reasons, fine corundum grains are typically used for blasting (“blasting corundum”). Blasting corundum is an artificial, mineral blasting medium and is made from high-quality bauxite or alumina melted in an arc furnace at over 2000° C. It is also used in the production of abrasives and abrasive papers. Blasting corundum is not hygroscopic. The selection of different grain sizes results in different degrees of roughness and therefore different design options.

The production of the satin-finished region of a pane surface by etching, for example with hydrofluoric acid as an etching medium, is preferred because the satin-finished region can be formed more homogeneously than by sandblasting. Depending on the method, concentration of the reactants, temperature of the etching medium and chemical composition of the glass, the optical appearance of the satin-finished pane surface can vary after treatment. In order to limit the etching to the desired region, adhesive film can be used, which is then removed after the etching process.

Another option for producing a satin-finished region of a pane surface is laser processing.

In preferred embodiments, the design element has a thickness of less than 50 μm, preferably less than 25 μm, particularly preferably less than 12.5 μm, most particularly preferably less than 5 μm.

In a preferred embodiment of the composite pane according to the invention, the design element is formed on the exterior-side surface of the outer pane or on the interior-side surface of the inner pane. This embodiment is particularly advantageous because, in the case of design elements formed on the exterior-side surface of the outer pane or on the interior-side surface of the inner pane, it is impossible for the design element to exert pressure on the active layer of the electro-optical functional element.

Particularly preferred are therefore embodiments in which the design element is formed as an imprint on the exterior-side surface of the outer pane, as an imprint on the interior-side surface of the inner pane, as an adhesive tape stuck to the exterior-side surface of the outer pane, as an adhesive tape stuck to the interior-side surface of the inner pane, as a satin-finished region of the exterior-side surface of the outer pane or as a satin-finished region of the interior-side surface of the inner pane.

The electro-optical functional element is preferably arranged over a large area in the composite pane. The electro-optical functional element is preferably smaller in area than the composite pane, for example the edges of the electro-optical functional element are spaced between 2 mm and 20 mm from the respective nearest edge of the composite pane. The electro-optical functional element is thus encapsulated by the thermoplastic intermediate layer and protected from contact with the surrounding atmosphere and from corrosion.

In a preferred embodiment of a composite pane according to the invention, the composite pane additionally has a third thermoplastic intermediate layer and the electro-optical functional element is circumferentially surrounded by the third thermoplastic intermediate layer. The third thermoplastic intermediate layer is frame-like with a recess into which the electro-optical functional element is inserted. The outer dimensions of the recess, i.e. the length and width, correspond to the dimensions of the electro-optical functional element, so that the latter is arranged flush in the recess. There is therefore no gap between the electro-optical functional element and the third thermoplastic intermediate layer. The third thermoplastic intermediate layer can be formed by a thermoplastic film into which the recess has been introduced by cutting. Alternatively, the third thermoplastic intermediate layer can also be composed of a plurality of film sections around the electro-optical functional element. The third thermoplastic intermediate layer preferably has the same thickness as the electro-optical functional element. If necessary, this can compensate for the local difference in thickness of the composite pane, which is introduced by the locally delimited electro-optical functional element, so that glass breakage during lamination can be avoided.

The electro-optical functional element is in particular a PDLC functional element, an SPD functional element, a PNLC functional element, an electrochromic functional element or a functional element with liquid crystal dye cells.

In a preferred embodiment of a composite pane according to the invention, the electro-optical functional element is a PDLC (polymer dispersed liquid crystal) functional element. The active layer of a PDLC functional element contains liquid crystals which are embedded in a polymer matrix. If no voltage is applied to the planar electrodes, the liquid crystals will be aligned in an unordered manner, which results in strong scattering of the light passing through the active layer. If a voltage is applied to the planar electrodes, the liquid crystals will align in a common direction and the transmittance of light through the active layer is increased. PDLC functional elements are known, for example, from US20150301367 A1.

In a further preferred embodiment of a composite pane according to the invention, the electro-optical functional element is an SPD functional element (SPD=suspended particle device). The principle is similar to that of PDLC functional elements, except that in SPD functional elements it is not liquid crystal droplets but suspension droplets, in which light-polarizing particles are suspended, that are embedded in a polymer matrix. Such systems are described, for example, in EP 0551138 A1.

In a further preferred embodiment of a composite pane according to the invention, the electro-optical functional element is a PNLC (polymer network liquid crystal) functional element. The active layer contains liquid crystals which are embedded in a polymer network, the mode of operation otherwise being analogous to a PDLC functional element.

In a further preferred embodiment of a composite pane according to the invention, the electro-optical functional element is an electrochromic functional element. In this case, the transmittance of visible light through the electro-optical functional element depends on the degree of embedding of ions. The ions are released, for example, by an ion storage layer and embedded in an electrochromic layer. The light transmittance can be influenced by the voltage which is applied to the electro-optical functional element and causes a migration of the ions. Suitable electrochromic layers contain, for example, at least tungsten oxide or vanadium oxide.

In a further preferred embodiment of a composite pane according to the invention, the electro-optical functional element is a functional element with liquid crystal dye cells (so-called guest-host cells).

PDLC, SPD, and PNLC functional elements, electrochromic functional elements, and functional elements with liquid crystal dye cells are commercially available as functional elements. The mentioned electro-optical functional elements and their mode of operation are known per se to a person skilled in the art, so a detailed description is not required here.

Delta E (ΔE) can be used to determine whether a color difference is perceived by an observer. ΔE is a measure of the distance between two colors and shows whether the difference between two colors can be perceived. It is therefore a relative measure with reference to the peculiarities of human color perception. A ΔE always refers to two colors that are to be compared. The ΔE is calculated by calculating the Euclidean distance between the a*, b* and L* values.

The symbols a* and b* are values of the L*a*b* color space, i.e. of a color model that describes all perceptible colors. L* indicates the brightness value and can have values between 0 and 100. a* indicates the chromaticity and color intensity between green and red, while b* indicates the chromaticity and color intensity between blue and yellow. The more negative or positive the values of b* and a* are, the more intense the hue. For values close to 0 for a* and b*, the color tone is rather achromatic, i.e. neutral.

The fact that the third color of the design element corresponds to the first color of the electro-optical functional element, i.e. the color of the electro-optical functional element in the first state, means in the context of the present application that the color difference ΔE between the third color of the design element and the first color of the electro-optical functional element is less than or equal to 10, preferably less than or equal to 5, particularly preferably less than or equal to 2. Therefore, an observer cannot perceive any color difference between the design element and the electro-optical functional element in the first state.

The formula for calculating ΔE is as follows:

$$Δ E = \sqrt{{( {L}_{1}^{*} - {L}_{2}^{*} )}^{2} + {( {a}_{1}^{*} - {a}_{2}^{*} )}^{2} + {( {b}_{1}^{*} - {b}_{2}^{*} )}^{2}}$$

where
L₁*=luminance of the electro-optical functional element in the first state
L₂*=luminance of the design element
a₁*=value for the green or red component of the first color of the electro-optical functional element
a₂*=value for the green or red component of the third color of the design element
b₁*=value for the blue or yellow component of the first color of the electro-optical functional element
b₂*=value for the blue or yellow component of the third color of the design element
ΔE=Euclidean distance between the L*a*b* values of the first color of the electro-optical functional element and the L*a*b* values of the third color of the design element

Common measurement methods for determining a*, b* and L* values of the L*a*b* color space (CIELAB) are generally known to a person skilled in the art.

As described above, the first color and the second color of the electro-optical functional element do not correspond to each other and the third color of the design element, which corresponds to the first color of the electro-optical functional element, therefore also does not correspond to the second color of the electro-optical functional element.

The fact that the third color of the design element does not correspond to the second color of the electro-optical functional element, i.e. the color of the electro-optical functional element in the second state, means in the context of this application that the color difference between the third color of the design element and the second color of the electro-optical functional element is greater than 10. An observer can therefore perceive a color difference between the design element and the electro-optical functional element in the second state.

The formula for calculating the color difference between the third color of the design element and the second color of the electro-optical functional element is analogous to the calculation of the color difference between the third color of the design element and the first color of the electro-optical functional element as follows:

$$Δ {E}^{′} = \sqrt{{( {L}_{3}^{*} - {L}_{2}^{*} )}^{2} + {( {a}_{3}^{*} - {a}_{2}^{*} )}^{2} + {( {b}_{3}^{*} - {b}_{2}^{*} )}^{2}}$$

where
L₃*=luminance of the electro-optical functional element in the second state
L₂*=luminance of the design element
a₃*=value for the green or red component of the second color of the electro-optical functional element
a₂*=value for the green or red component of the third color of the design element
b₃*=value for the blue or yellow component of the second color of the electro-optical functional element
b₂*=value for the blue or yellow component of the third color of the design element
ΔE′=Euclidean distance between the L*a*b* values of the second color of the electro-optical functional element and the L*a*b* values of the third color of the design element

In one embodiment of a composite pane according to the invention, the electro-optical functional element has a first haze and a first light transmittance in the first state and a second haze and a second light transmittance in the second state and the design element has a third haze and a third light transmittance. The third haze and the third light transmittance are adapted to the first haze, the first light transmittance, the second haze and the second light transmittance in such a way that the design element does not visually stand out to an observer when the electro-optical functional element is in the first state and the design element visually stands out to an observer when the electro-optical functional element is in the second state.

For the purposes of the invention, “visually standing out” means that the design element, including its contours, is visible to the viewer as a separate element, and “not visually standing out” means that the design element is not visible to the viewer as a separate element, but is perceived together with the electro-optical functional element as a homogeneous element and the viewer cannot see any contours of the design element.

In a preferred embodiment of a composite pane according to the invention, the design element has a haze of less than 30%, preferably less than 15%, particularly preferably less than 5%.

In a preferred embodiment of a composite pane according to the invention, the electro-optical functional element is a PDLC functional element, an SPD functional element or a PNLC functional element and the design element has a haze of less than 30%, preferably less than 15%, particularly preferably less than 5%.

Common measurement methods for determining haze are generally known to a person skilled in the art.

In one embodiment of a composite pane according to the invention, the electro-optical functional element is a PDLC functional element, an SPD functional element or a PNLC functional element and the design element has a light transmittance of at least 70%, preferably of at least 80%, particularly preferably of at least 90%.

The light transmittance refers to the transmittance in the visible spectral range and is expressed here as a percentage. In particular, the term “light transmittance” refers to the light transmittance according to the standard ECE R43 Revision 4 of Apr. 3, 2017, illuminant A, which is also abbreviated to TL or TL(A).

According to the invention, a composite pane is also provided which comprises at least an outer pane with an exterior-side surface and an interior-side surface, a first thermoplastic intermediate layer, an electro-optical functional element, a second thermoplastic intermediate layer, a design element and an inner pane with an exterior-side surface and an interior surface,
wherein the electro-optical functional element is arranged in a region of the composite pane between the outer pane and the inner pane,
the first thermoplastic intermediate layer is arranged between the outer pane and the electro-optical functional element,
the second thermoplastic intermediate layer is arranged between the electro-optical functional element and the inner pane,
the design element is arranged in a region of the composite pane which, when viewed through the composite pane, lies completely in the region in which the electro-optical functional element is arranged,
the electro-optical functional element can be electrically controlled from a first state, in which said functional element has a first color, a first haze and a first transmittance, to a second state, in which said functional element has a second color, a second haze and a second transmittance, and vice versa,
and wherein the design element has a third color, a third haze and a third transmittance, the third color corresponds to the first color, and the third haze and the third transmittance are adapted to the first haze and the first transmittance of the electro-optical functional element and to the second haze and the second transmittance of the electro-optical functional element in such a way that the design element does not visually stand out to an observer when the electro-optical functional element is in the first state and visually stands out to an observer when the electro-optical functional element is in the second state.

In one embodiment of the invention, the electro-optical functional element is divided by insulation lines into segments. The individual segments are connected to the voltage source independently of one another so that they can be controlled separately, i.e. the segments can be electrically controlled independently of one another. Thus, different segments of the electro-optical functional element can be electrically controlled independently of one another from the first state, in which they have a first color, to the second state, in which they have a second color, and vice versa.

In one embodiment, the composite pane according to the invention additionally has a peripheral opaque cover print, in particular made of a black enamel, which serves in particular to protect the adhesive used to install the composite pane from UV radiation and to visually conceal said adhesive. This peripheral opaque cover print is preferably also used to cover one or more edges of the electro-optical functional element.

The first thermoplastic intermediate layer and the second thermoplastic intermediate layer and the optionally present third thermoplastic intermediate layer contain, independently of one another in one embodiment, at least polyvinyl butyral (PVB), ethylene vinyl acetate (EVA), polyurethane (PU) or mixtures or copolymers or derivatives thereof, preferably polyvinyl butyral (PVB), particularly preferably polyvinyl butyral (PVB) and additives known to a person skilled in the art, such as plasticizers.

The first thermoplastic intermediate layer and the second thermoplastic intermediate layer and the optionally present third thermoplastic intermediate layer can be formed independently of one another by a single film or else by more than one film.

The thickness of the first thermoplastic intermediate layer and that of the second thermoplastic intermediate layer are, independently of one another, preferably from 0.2 mm to 2 mm, particularly preferably from 0.3 mm to 1 mm, for example 0.38 mm or 0.78 mm.

The first thermoplastic intermediate layer and/or the second thermoplastic intermediate layer and/or the third thermoplastic intermediate layer can, independently of one another, also be a functional intermediate layer, in particular an intermediate layer with acoustically damping properties, an intermediate layer reflecting infrared radiation, an intermediate layer absorbing infrared radiation or an intermediate layer absorbing UV radiation.

The outer pane and the inner pane are preferably produced from transparent glass, in particular soda-lime glass, which is customary for window panes. In principle, however, the panes can also be produced from other types of glass (for example borosilicate glass, quartz glass, aluminosilicate glass) or transparent plastics (for example polymethyl methacrylate or polycarbonate). The thickness of the outer pane and the inner pane can vary widely. Preferably, panes having a thickness in the range from 0.8 mm to 5 mm, preferably from 1.4 mm to 2.5 mm, are used, for example those with the standard thicknesses of 1.6 mm or 2.1 mm. Independently of each other the outer pane and the inner panes can be not prestressed, partially prestressed or prestressed. If at least one of the panes is to be prestressed, this can be thermal or chemical prestressing.

The outer pane and/or the inner pane can have further suitable coatings known per se, e.g., anti-reflective coatings, non-stick coatings, anti-scratch coatings, photocatalytic coatings, or sun protection coatings, or low-E coatings.

The composite pane according to the invention can comprise one or more additional intermediate layers, in particular functional intermediate layers. An additional intermediate layer can be, in particular, an intermediate layer with acoustically damping properties, an intermediate layer reflecting infrared radiation, an intermediate layer absorbing infrared radiation, or an intermediate layer absorbing UV radiation. If there is a plurality of additional intermediate layers, they can also have different functions.

The fact that the design element is arranged in a region of the composite pane which, when viewed through the composite pane, lies completely in the region in which the electro-optical functional element is arranged, means that the orthogonal projection from the design element to the plane of the electro-optical functional element is arranged completely within the electro-optical functional element.

Since the design element is arranged in a region of the composite pane which, when viewed through the composite pane, lies completely in the region in which the electro-optical functional element is arranged, the outer dimensions of the design element cannot be larger than those of the electro-optical functional element. The region in which the design element is arranged and the region in which the electro-optical functional element is arranged are in particular also not congruent, i.e. the region in which the electro-optical functional element is arranged is in particular larger than the region in which the design element is arranged.

The area of the design element is preferably less than or equal to 80%, particularly preferably less than or equal to 50%, most particularly preferably less than or equal to 25% of the area of the electro-optical functional element.

The area of the design element is preferably at least 0.01%, particularly preferably at least 0.1%, most particularly preferably at least 1.0% of the area of the electro-optical functional element.

According to the invention, there is also a method for producing a composite pane according to the invention.

In one embodiment of the method, the method comprises at least the following steps:
a) providing a stack sequence at least comprising an outer pane with an exterior-side surface and an interior-side surface, a first thermoplastic intermediate layer, an electro-optical functional element, a second thermoplastic intermediate layer, a design element and an inner pane with an exterior-side surface and an interior-side surface,
wherein the electro-optical functional element is arranged in a region of the composite pane between the outer pane and the inner pane,
the first thermoplastic intermediate layer is arranged between the outer pane and the electro-optical functional element,
the second thermoplastic intermediate layer is arranged between the electro-optical functional element and the inner pane,
the design element is arranged in a region of the composite pane which, when viewed through the composite pane, lies completely in the region in which the electro-optical functional element is arranged,
the electro-optical functional element can be electrically controlled from a first state, in which said functional element has a first color, to a second state, in which said functional element has a second color, and vice versa,
and wherein the design element has a third color which corresponds to the first color of the electro-optical functional element;
b) lamination of the stack sequence.

In this embodiment of the method, the design element is introduced into the stack sequence before lamination. By means of this embodiment of the method, in particular a composite pane according to the invention can be produced in which the design element is formed as an imprint on one of the surfaces of the panes, as an imprint on the first or the second thermoplastic intermediate layer, as an insert element arranged between the first thermoplastic intermediate layer and the electro-optical functional element or between the second thermoplastic intermediate layer and the electro-optical functional element, as an adhesive tape stuck to one of the pane surfaces or as a satin-finished region of one of the pane surfaces.

In an alternative embodiment, the design element is applied to a laminated stack sequence only after lamination. In this alternative embodiment, the method comprises at least the following steps:
a) providing a stack sequence at least comprising an outer pane with an exterior-side surface and an interior-side surface, a first thermoplastic intermediate layer, an electro-optical functional element, a second thermoplastic intermediate layer and an inner pane with an exterior-side surface and an interior-side surface,
wherein the electro-optical functional element is arranged in a region of the composite pane between the outer pane and the inner pane,
the first thermoplastic intermediate layer is arranged between the outer pane and the electro-optical functional element,
the second thermoplastic intermediate layer is arranged between the functional element and the inner pane,
the electro-optical functional element can be electrically controlled from a first state, in which said functional element has a color, to a second state, in which said functional element has a second color, and vice versa,
b) lamination of the stack sequence to form a laminated stack sequence;
c) applying a design element in a region on the exterior-side surface of the outer pane or on the interior-side surface of the inner pane of the laminated stack sequence, wherein the region in which the design element is applied, when viewed through the composite pane, lies completely in the region in which the electro-optical functional element is arranged, and wherein the design element has a third color which corresponds to the first color of the electro-optical functional element.

In this alternative embodiment of the method, the design element is thus introduced into the laminated stack sequence after lamination. By means of this embodiment of the method, a composite pane according to the invention can consequently be produced in which the design element is formed as an imprint on the exterior-side surface of the outer pane, as an imprint on the interior-side surface of the inner pane, as an adhesive tape stuck to the exterior-side surface of the outer pane, as an adhesive tape stuck to the interior-side surface of the inner pane, as a satin-finished region of the exterior-side surface of the outer pane or as a satin-finished region of the interior-side surface of the inner pane.

The stack sequence can be laminated in a method according to the invention using conventional lamination methods. For example, so-called autoclave methods can be carried out at an elevated pressure of approximately 10 bar to 15 bar and at temperatures of 130° C. to 145° C. for approximately 2 hours. Alternatively, methods without autoclaving are also possible. Vacuum bag or vacuum ring methods known per se operate, for example, at approximately 200 mbar and 80° C. to 110° C. The stack sequence may also be pressed in a calender between at least one pair of rollers. Systems of this type are known for producing panes and normally have at least one heating tunnel upstream of a pressing unit. The temperature during pressing is, for example, from 40° C. to 150° C. Combinations of calender and autoclave methods have proven particularly successful in practice. Vacuum laminators can be used as an alternative. These consist of one or more heatable and evacuable chambers, in which the stack sequence is laminated within, for example, approximately 60 minutes at reduced pressures of 0.01 mbar to 800 mbar and temperatures from 80° C. to 170° C.

The preferred embodiments of the composite pane according to the invention described above also correspondingly apply to methods for producing a composite pane according to the invention and vice versa.

The invention also relates to the use of a composite pane according to the invention in buildings, in particular in the access or window region, as a built-in part in furniture and appliances, or in means of transport for traffic on land, in the air or on water, in particular in trains, ships and motor vehicles, for example as a windshield, rear pane, side pane and/or roof pane.

In the following, the invention is explained in more detail with the aid of drawings and examples of embodiments. Elements that are identical or have the same effect are provided with the same reference signs. In a simplified, not-to-scale representation:

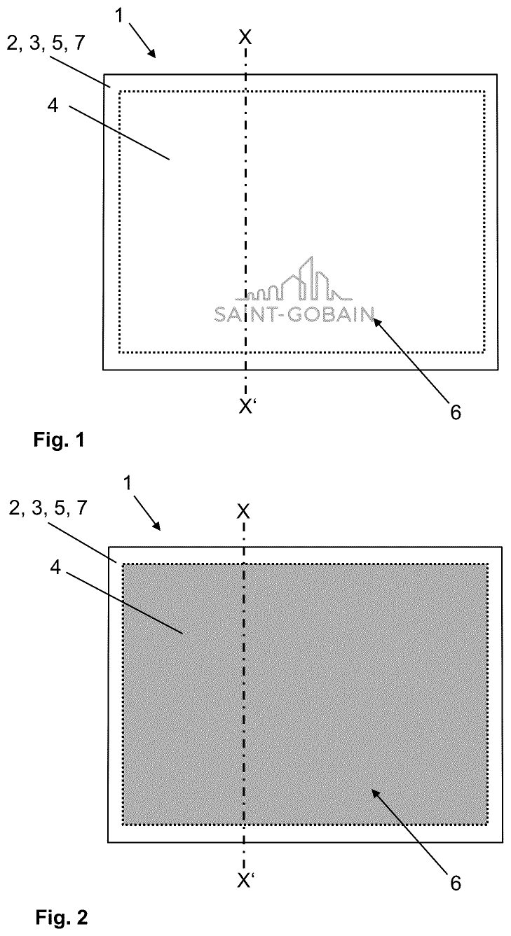

FIG. 1 and FIG. 2 show a plan view of an embodiment of a composite pane according to the invention,

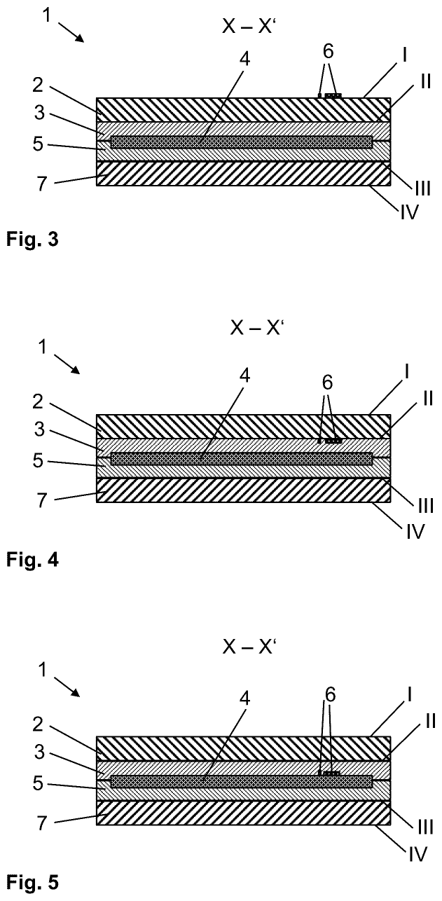

FIG. 3 shows a cross section through an embodiment of a composite pane according to the invention,

FIG. 4 shows a cross section through another embodiment of a composite pane according to the invention,

FIG. 5 shows a cross section through another embodiment of a composite pane according to the invention,

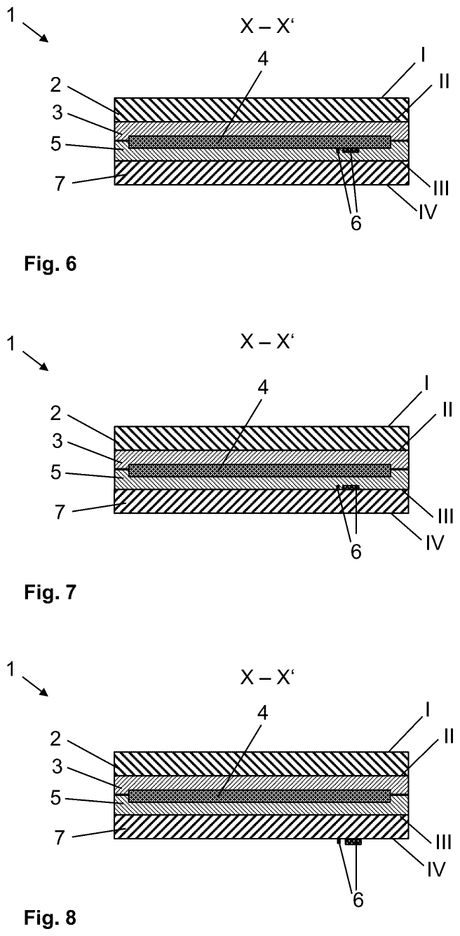

FIG. 6 shows a cross section through another embodiment of a composite pane according to the invention,

FIG. 7 shows a cross section through another embodiment of a composite pane according to the invention,

FIG. 8 shows a cross section through another embodiment of a composite pane according to the invention,

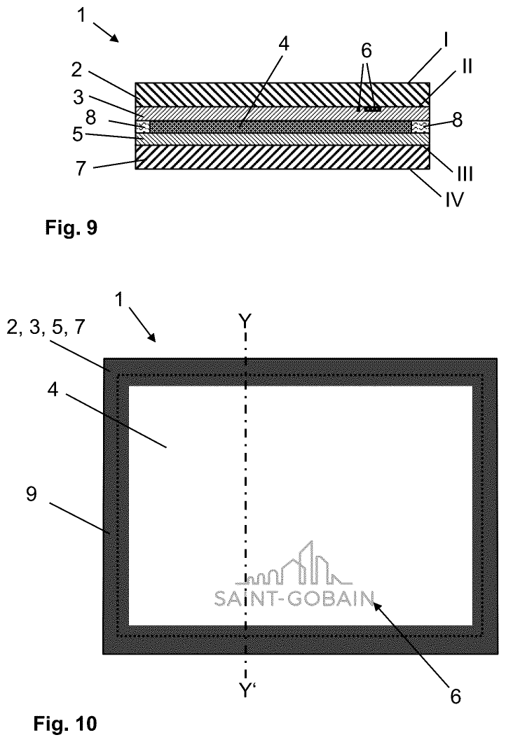

FIG. 9 shows a cross section through another embodiment of a composite pane according to the invention,

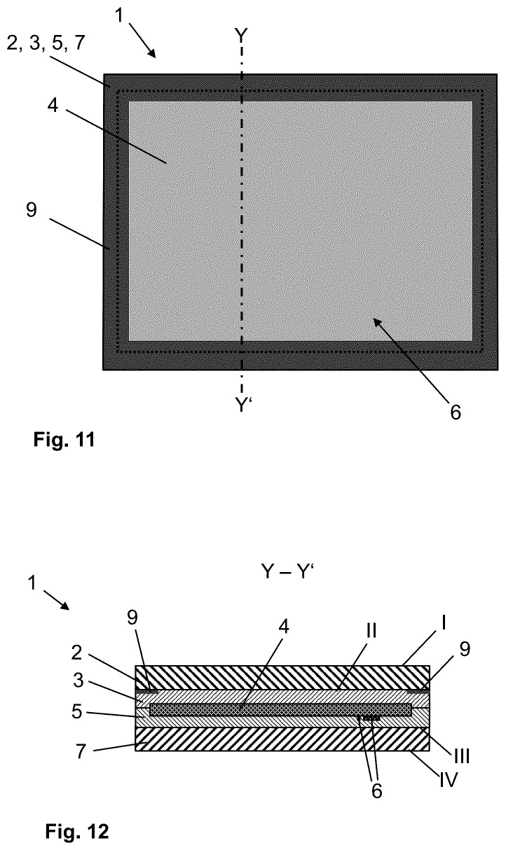

FIG. 10 and FIG. 11 show a plan view of another embodiment of a composite pane according to the invention,

FIG. 12 shows a cross section through another embodiment of a composite pane according to the invention,

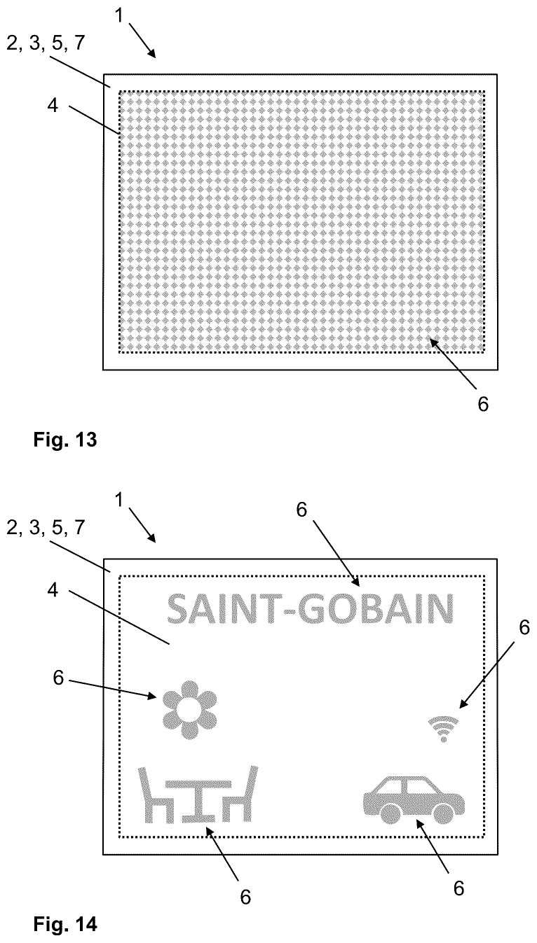

FIG. 13 is a plan view of another embodiment of a composite pane according to the invention,

FIG. 14 is a plan view of another embodiment of a composite pane according to the invention,

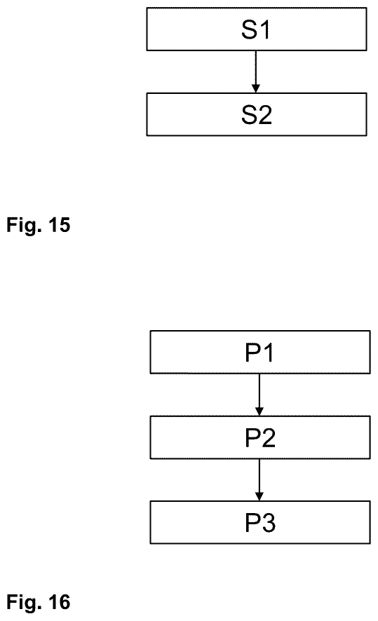

FIG. 15 is a flow chart of a method for producing a composite pane according to the invention.

FIG. 16 is a flow chart of another method for producing a composite pane according to the invention.

FIG. 1 and FIG. 2 each show the plan view of an embodiment of a composite pane 1 according to the invention, wherein FIG. 1 and FIG. 2 only differ in that in FIG. 1 the electro-optical functional element 4 is in the second state, whereas in FIG. 2 the electro-optical functional element 4 is in the first state. The composite pane 1 shown in FIG. 1 and FIG. 2 comprises an outer pane 2, a first thermoplastic intermediate layer 3, an electro-optical functional element 4, a second thermoplastic intermediate layer 5, a design element 6 and an inner pane 7. The electro-optical functional element 4 is arranged in a region of the composite pane 1. The design element 6 is arranged in a region of the composite pane 1 which, when viewed through the composite pane 1, lies completely in the region in which the electro-optical functional element 4 is arranged. In the embodiment shown in FIGS. 1 and 2, the design element 6 is formed as lettering with a logo. As can be seen from FIGS. 1 and 2, the design element 6 has a third color which corresponds to the first color of the electro-optical functional element 4 in the first state, and thus the design element 6 only stands out visually when the electro-optical functional element 4 is in the second state and is not recognizable to an observer as a separate element, but is perceived by the observer together with the electro-optical functional element 4 as a homogeneous element when the electro-optical functional element 4 is in the first state. When the electro-optical functional element 4 is in the first state, as can be seen from FIG. 2, no contours of the design element are visible to the observer. The composite pane 1 shown in FIGS. 1 and 2 can be constructed as shown in cross section in FIGS. 3 to 9. For better illustration, the side edge of the electro-optical functional element 4 is shown in dashed lines in FIGS. 1 and 2.

FIG. 3 shows a cross section along the section line X′-X through an embodiment of the composite pane 1 according to the invention shown in FIG. 1 and FIG. 2. In the embodiment shown in FIG. 3, the composite pane 1 comprises an outer pane 2, a first thermoplastic intermediate layer 3, an electro-optical functional element 4, a second thermoplastic intermediate layer 5, a design element 6 and an inner pane 7. The electro-optical functional element 4 is arranged in a region of the composite pane 1. The design element 6 is arranged on the exterior-side surface I of the outer pane 2 in a region of the composite pane 1 which, when viewed through the composite pane 1, lies completely in the region in which the electro-optical functional element 4 is arranged. In the embodiment shown in FIG. 3, the design element 6 is formed, for example, as an imprint or an adhesive tape or a satin-finished region. The thickness of the outer pane 2 and the thickness of the inner pane 7 are, for example, 2.1 mm. The first thermoplastic intermediate layer 3 consists, for example, of PVB and is 0.76 mm thick. The second thermoplastic intermediate layer 5 consists, for example, of PVB and is 0.76 mm thick. The electro-optical functional element 4 is, for example, a PDLC element.

FIG. 4 shows a cross section along the section line X′-X through a further embodiment of the composite pane 1 according to the invention shown in FIG. 1 and FIG. 2. The embodiment shown in FIG. 4 differs from that shown in FIG. 3 only in that the design element 6 is not arranged on the exterior-side surface I of the outer pane 2, but is arranged between the outer pane 2 and the first thermoplastic intermediate layer 3. In the embodiment shown in FIG. 4, the design element 6 is formed, for example, as an imprint on the interior-side surface II of the outer pane 2, as an imprint on the surface of the first thermoplastic intermediate layer 3 adjacent to the outer pane 2, as an adhesive tape on the interior-side surface II of the outer pane 2, as an insert element or as a satin-finished region of the interior-side surface II of the outer pane 2.

FIG. 5 shows a cross section along the section line X′-X through a further embodiment of the composite pane 1 according to the invention shown in FIG. 1 and FIG. 2. The embodiment shown in FIG. 5 differs from that shown in FIG. 3 only in that the design element 6 is not arranged on the exterior-side surface I of the outer pane 2, but is arranged between the first thermoplastic intermediate layer 3 and the electro-optical functional element 4. In the embodiment shown in FIG. 5, the design element 6 is formed, for example, as an imprint on the surface of the first thermoplastic intermediate layer 3 adjacent to the electro-optical functional element 4 or as an insert element.

FIG. 6 shows a cross section along the section line X′-X through a further embodiment of the composite pane 1 according to the invention shown in FIG. 1 and FIG. 2. The embodiment shown in FIG. 6 differs from that shown in FIG. 3 only in that the design element 6 is not arranged on the exterior-side surface I of the outer pane 2, but is arranged between the electro-optical functional element 4 and the second thermoplastic intermediate layer 5. In the embodiment shown in FIG. 6, the design element 6 is formed, for example, as an imprint on the surface of the second thermoplastic intermediate layer 5 adjacent to the electro-optical functional element 4 or as an insert element.

FIG. 7 shows a cross section along the section line X′-X through a further embodiment of the composite pane 1 according to the invention shown in FIG. 1 and FIG. 2. The embodiment shown in FIG. 7 differs from that shown in FIG. 3 only in that the design element 6 is not arranged on the exterior-side surface I of the outer pane 2, but is arranged between the second thermoplastic intermediate layer 5 and the inner pane 7. In the embodiment shown in FIG. 7, the design element 6 is formed, for example, as an imprint on the exterior-side surface III of the inner pane 7, as an imprint on the surface of the second thermoplastic intermediate layer 5 adjacent to the inner pane 7, as an adhesive tape on the exterior-side surface III of the inner pane 7, as an insert element or as a satin-finished region of the exterior-side surface III of the inner pane 7.

FIG. 8 shows a cross section along the section line X′-X through a further embodiment of the composite pane 1 according to the invention shown in FIG. 1 and FIG. 2. The embodiment shown in FIG. 8 differs from that shown in FIG. 3 only in that the design element 6 is not arranged on the exterior-side surface I of the outer pane 2, but is arranged on the inner-side surface IV of the inner pane 7. In the embodiment shown in FIG. 8, the design element 6 is formed, for example, as an imprint or an adhesive tape or a satin-finished region.

FIG. 9 shows a cross section through another embodiment of a composite pane 1 according to the invention. The embodiment shown in FIG. 9 differs from that shown in FIG. 4 only in that the composite pane 1 has a third thermoplastic intermediate layer 8 which is arranged between the first thermoplastic intermediate layer 3 and the second thermoplastic intermediate layer 5 and which has a recess in which the electro-optical functional element 4 is accommodated. The electro-optical functional element 4 is thus surrounded in a frame-like manner by the third thermoplastic intermediate layer 8. It is understood that the embodiments shown in FIGS. 3 and 5 to 8 can also be modified such that the composite pane 1 additionally has a third thermoplastic intermediate layer 8 with a recess in which the electro-optical functional element 4 is accommodated.

FIG. 10 and FIG. 11 each show the plan view of a further embodiment of a composite pane 1 according to the invention, wherein FIG. 10 and FIG. 11 differ only in that in FIG. 10 the electro-optical functional element 4 is in the second state, whereas in FIG. 11 the electro-optical functional element 4 is in the first state. The embodiment shown in FIGS. 10 and 11 differs from that shown in FIGS. 1 and 2 only in that the composite pane 1 has a peripheral opaque cover print 9, for example made of black enamel. In the embodiment shown in FIGS. 10 and 11, the edges of the electro-optical functional element 4 are covered by the peripheral opaque cover print 9 when viewed through the composite pane 1. For better illustration, the side edge of the electro-optical functional element 4 is shown in dashed lines in FIGS. 10 and 11.

FIG. 12 shows a cross section along the section line Y-Y′ through an embodiment of the composite pane 1 according to the invention shown in FIG. 10 and FIG. 11. In the embodiment shown in FIG. 12, the composite pane 1 comprises an outer pane 2, a first thermoplastic intermediate layer 3, an electro-optical functional element 4, a second thermoplastic intermediate layer 5, a design element 6 and an inner pane 7. The electro-optical functional element 4 is arranged in a region of the composite pane 1. The design element 6 is arranged between the electro-optical functional element 4 and the second thermoplastic intermediate layer 5 in a region of the composite pane 1 which, when viewed through the composite pane 1, lies completely in the region in which the electro-optical functional element 4 is arranged. In the embodiment shown in FIG. 12, the design element 6 is formed, for example, as an imprint on the surface of the second thermoplastic intermediate layer 5 facing the electro-optical functional element 4 or as an insert element. The thickness of the outer pane 2 and the thickness of the inner pane 7 are, for example, 2.1 mm. The first thermoplastic intermediate layer 3 consists, for example, of PVB and is 0.76 mm thick. The second thermoplastic intermediate layer 5 consists, for example, of PVB and is 0.76 mm thick. The electro-optical functional element 4 is, for example, a PDLC element. A peripheral opaque cover print 9 made of a black enamel is applied to the interior-side surface II of the outer pane 2. The peripheral opaque cover print 9 can alternatively or additionally be applied to the exterior-side surface I of the outer pane, the exterior-side surface III of the inner pane 7 or the interior-side surface IV of the inner pane 7. It is understood that the embodiments shown in FIGS. 3, 4, 5, 7, 8 and 9 can also be modified such that the composite pane 1 additionally has a peripheral opaque cover print 9.

FIG. 13 shows the top view of a further embodiment of a composite pane 1 according to the invention, in which the functional element 4 is in the second state. The embodiment shown in FIG. 13 differs from that shown in FIG. 1 only with regard to the configuration of the design element 6. In the embodiment shown in FIG. 13, the design element 6 is formed from a plurality of diamond-shaped elements which together form a uniform pattern.

FIG. 14 shows the top view of a further embodiment of a composite pane 1 according to the invention, in which the electro-optical functional element 4 is in the second state. The embodiment shown in FIG. 14 differs from that shown in FIG. 1 only with regard to the configuration of the design element 6. In the embodiment shown in FIG. 14, the design element 6 is formed from a plurality of elements, some of these elements each forming lettering, a symbol or a simple graphic.

FIG. 15 shows a flow chart of a method for producing a composite pane 1 according to the invention. The method comprises, in a first step S1, providing a stack sequence comprising at least an outer pane 2 with an exterior-side surface I and an interior-side surface II, a first thermoplastic intermediate layer 3, an electro-optical functional element 4, a second thermoplastic intermediate layer 5, a design element 6 and an inner pane 7 with an exterior-side surface III and an interior-side surface IV, wherein the electro-optical functional element 4 is arranged in a region of the composite pane 1 between the outer pane 2 and the inner pane 7,

the first thermoplastic intermediate layer 3 is arranged between the outer pane 2 and the electro-optical functional element 4, the second thermoplastic intermediate layer 5 is arranged between the electro-optical functional element 4 and the inner pane 7, the design element 6 is arranged in a region of the composite pane 1 which, when viewed through the composite pane 1, lies completely in the region in which the electro-optical functional element 4 is arranged, the electro-optical functional element 4 can be electrically controlled from a first state, in which said functional element has a first color, to a second state, in which said functional element has a second color, and vice versa, and wherein the design element 6 has a third color which corresponds to the first color of the electro-optical functional element 4 in the first state. In a subsequent second step S2, the method comprises the lamination of the stack sequence provided in the first step S1.

FIG. 16 shows a flow chart of an alternative method for producing a composite pane 1 according to the invention. The method comprises, in a first step P1, providing a stack sequence at least comprising an outer pane 2 with an exterior-side surface I and an interior-side surface II, a first thermoplastic intermediate layer 3, an electro-optical functional element 4, a second thermoplastic intermediate layer 5 and an inner pane 7 with an exterior-side surface III and an interior-side surface IV, wherein the functional element 4 is arranged in a region of the composite pane 1 between the outer pane 2 and the inner pane 7, the first thermoplastic intermediate layer 3 is arranged between the outer pane 2 and the functional element 4, the second thermoplastic intermediate layer 5 is arranged between the electro-optical functional element 4 and the inner pane 7, and the electro-optical functional element 4 can be electrically controlled from a first state, in which said functional element has one color, to a second state, in which said functional element has a second color, and vice versa. In a subsequent second step P2, the stack sequence provided in step P1 is laminated. In a subsequent third step P3, the method comprises applying a design element 6 in a region on the exterior-side surface I of the outer pane 2 or the interior-side surface IV of the inner pane 7 of the laminated stack sequence, wherein the region in which the design element 6 is applied lies completely in the region in which the electro-optical functional element 4 is arranged when viewed through the laminated stack sequence, and wherein the design element 6 has a third color which corresponds to the first color of the electro-optical functional element 4 in the first state.

### LIST OF REFERENCE SIGNS

1 Composite pane
2 Outer pane
3 First thermoplastic intermediate layer
4 Electro-optical functional element
5 Second thermoplastic intermediate layer
6 Design element
7 Inner pane
8 Third thermoplastic intermediate layer
9 Cover print
I Exterior-side surface of the outer pane
II Interior-side surface of the outer pane
III Exterior-side surface of the inner pane
IV Interior-side surface of the inner pane
X-X′ Section line
Y-Y′ Section line

1. A composite pane comprising an outer pane with an exterior-side surface and an interior-side surface, a first thermoplastic intermediate layer, an electro-optical functional element, a second thermoplastic intermediate layer, a design element and an inner pane with an exterior-side surface and an interior-side surface,
wherein the electro-optical functional element is arranged in a region of the composite pane between the outer pane and the inner pane,
the first thermoplastic intermediate layer is arranged between the outer pane and the electro-optical functional element,
the second thermoplastic intermediate layer is arranged between the electro-optical functional element and the inner pane,
the design element is arranged in a region of the composite pane which, when viewed through the composite pane, lies completely in the region in which the electro-optical functional element is arranged,
the electro-optical functional element is electrically controllable from a first state, in which the electro-optical functional element has a first color, to a second state, in which the electro-optical functional element has a second color, and vice versa,
and the design element has a third color which corresponds to the first color of the electro-optical functional element.

2. The composite pane according to claim 1, wherein the design element is formed as an imprint on the exterior-side surface of the outer pane, as an imprint on the interior-side surface of the outer pane, as an imprint on the exterior-side surface of the inner pane, as an imprint on the interior-side surface of the inner pane, as an imprint on the first thermoplastic intermediate layer or as an imprint on the second thermoplastic intermediate layer.

3. The composite pane according to claim 1, wherein the design element is formed as an insert element and is arranged between the electro-optical functional element and the first thermoplastic intermediate layer or between the electro-optical functional element and the second thermoplastic intermediate layer or between the first thermoplastic intermediate layer and the outer pane or between the second thermoplastic intermediate layer and the inner pane.

4. The composite pane according to claim 3, wherein the insert element comprises or consists of colored PET, PVB, PE or EVA.

5. The composite pane according to claim 1, wherein the design element is formed as an adhesive tape stuck to the exterior-side surface of the outer pane, as an adhesive tape stuck to the interior-side surface of the outer pane, as an adhesive tape stuck to the exterior-side surface of the inner pane or as an adhesive tape stuck to the interior-side surface of the inner pane.

6. The composite pane according to claim 1, wherein the design element is formed as a satin-finished region of the exterior-side surface of the outer pane, as a satin-finished region of the interior-side surface of the outer pane, as a satin-finished region of the exterior-side surface of the inner pane or as a satin-finished region of the interior-side surface of the inner pane.

7. The composite pane according to claim 1, wherein the design element is formed on the exterior-side surface of the outer pane or on the interior-side surface of the inner pane.

8. The composite pane according to claim 1, wherein the design element has a thickness of less than 50 μm.

9. The composite pane according to claim 1, additionally comprising a third thermoplastic intermediate layer which is arranged between the outer pane and the inner pane, has a recess, and surrounds the electro-optical functional element as a frame.

10. The composite pane according to claim 1, wherein the electro-optical functional element is a PDLC functional element, an SPD functional element, a PNLC functional element, an electrochromic functional element or a functional element with liquid crystal dye cells.

11. The composite pane according to claim 1, wherein the electro-optical functional element has a first haze and a first light transmittance in the first state and a second haze and a second light transmittance in the second state and the design element has a third haze and a third light transmittance, and the third haze and the third light transmittance are adapted to the first haze, the first light transmittance, the second haze and the second light transmittance in such a way that the design element does not visually stand out to an observer when the electro-optical functional element is in the first state and the design element visually stands out to an observer when the electro-optical functional element is in the second state.

12. The composite pane according to claim 1, wherein the electro-optical functional element is divided by insulation lines into segments which are electrically controllable independently of one another and/or wherein the composite pane additionally comprises a peripheral opaque cover print.

13. A method for producing a composite pane according to claim 1, comprising:
providing a stack sequence at least comprising an outer pane with an exterior-side surface and an interior-side surface, a first thermoplastic intermediate layer, an electro-optical functional element, a second thermoplastic intermediate layer, a design element and an inner pane with an exterior-side surface and an interior-side surface,
wherein the electro-optical functional element is arranged in a region of the composite pane between the outer pane and the inner pane,
the first thermoplastic intermediate layer is arranged between the outer pane and the electro-optical functional element,
the second thermoplastic intermediate layer is arranged between the electro-optical functional element and the inner pane,
the design element is arranged in a region of the composite pane which, when viewed through the composite pane, lies completely in the region in which the electro-optical functional element is arranged,
the electro-optical functional element can be electrically controlled from a first state, in which the functional element has a first color, to a second state, in which the functional element has a second color, and vice versa,
and wherein the design element has a third color which corresponds to the first color of the electro-optical functional element, and
laminating the stack sequence.

14. A method for producing a composite pane according to claim 1, comprising:
providing a stack sequence comprising at least an outer pane with an exterior-side surface and an interior-side surface, a first thermoplastic intermediate layer, an electro-optical functional element, a second thermoplastic intermediate layer and an inner pane with an exterior-side surface and an interior-side surface,
wherein the electro-optical functional element is arranged in a region of the composite pane between the outer pane and the inner pane,
the first thermoplastic intermediate layer is arranged between the outer pane and the electro-optical functional element,
the second thermoplastic intermediate layer is arranged between the electro-optical functional element and the inner pane,
and the electro-optical functional element can be electrically controlled from a first state, in which the electro-optical functional element has a first color, to a second state, in which the electro-optical functional element has a second color, and vice versa;
laminating the stack sequence to form a laminated stack sequence, and
applying a design element in a region on the exterior-side surface of the outer pane or the interior-side surface of the inner pane of the laminated stack sequence, wherein the region in which the design element is applied, when viewed through the laminated stack sequence, lies completely in the region in which the electro-optical functional element is arranged, and wherein the design element has a third color which corresponds to the first color of the electro-optical functional element.

15. A method comprising providing the composite pane according to claim 1 in a building, as a built-in part in furniture or appliance, or in a vehicle of transport for traffic on land, in the air or on water.

16. The composite pane according to claim 8, wherein the design element has a thickness of less than 25 μm.

17. The composite pane according to claim 16, wherein the design element has a thickness of less than 12.5 μm.

18. The composite pane according to claim 17, wherein the design element has a thickness of less than 5 μm.

19. The composite pane according to claim 12, wherein the opaque cover print is black enamel.

20. The method according to claim 15, wherein the composite pane is a windshield, rear pane, side pane and/or roof pane.
